(19) United States
(12) Patent Application Publication
(10) Pub. No.: US 2011/0240137 A1
(43) Pub. Date: Oct. 6, 2011

(54) OVERPRESSURE HATCH INTENDED TO BE MOUNTED ON A WALL OF A TURBOJET ENGINE NACELLE

(75) Inventor: Guy Bernard Vauchel, Harfleur (FR)

(73) Assignee: AIRCELLE, Gonfreville L'Orcher (FR)

(21) Appl. No.: 13/132,677

(22) PCT Filed: Nov. 18, 2009
(86) PCT No.: PCT/FR2009/001324

§ 371 Date: Jun. 3, 2011

(30) Foreign Application Priority Data
Dec. 12, 2008 (FR) 0806991

(51) Int. Cl. B64D 29/00

(52) U.S. Cl. 137/15.2

(57) ABSTRACT

The invention relates to an overpressure hatch (21) intended to be mounted on a wall (23) of a nacelle (1) for a turbojet engine (5), the overpressure hatch (21) comprising a support (22) intended to be fixed to the wall (23), and at least one discharge element (25) able to move with respect to said support (22), said hatch (21) comprising at least one part (27) of lower mechanical strength than the remainder of the overpressure hatch (21) so that air at an overpressure inside the nacelle (1) can be discharged when the internal pressure applied to said hatch (21) more or less reaches a threshold pressure level lower than the maximum pressure that the nacelle structure can withstand. The invention also relates to a turbojet engine nacelle comprising at least one hatch (21) according to the invention.

### TECHNICAL FIELD

The present invention relates to an overpressure hatch intended to be mounted on the outer wall of a turbojet engine nacelle, said wall being in contact with the flow of air deflected around the nacelle, as well as a turbojet engine nacelle including such a hatch.

### BACKGROUND

An aircraft is moved by several turbojet engines each housed in a nacelle also housing a set of related actuating devices connected to its operation and performing various functions when the turbojet engine is operating or stopped. These related actuating devices include in particular a mechanical thrust reverser actuating system.

A nacelle generally has a tubular structure comprising an air intake upstream of the turbojet engine, a central section intended to surround a fan of the turbojet engine, a downstream section housing thrust reverser means and intended to surround the combustion chamber of the turbojet engine. The tubular structure generally ends with a jet nozzle, the outlet of which is situated downstream of the turbojet engine.

“Downstream” here refers to the direction corresponding to the direction of the cold air flow penetrating the turbojet engine. “Upstream” designates the opposite direction.

Modern nacelles are intended to house a double flow turbojet engine capable of generating, via rotating fan blades, a hot air flow (also called “primary flow”) coming from the turbojet engine combustion chamber, and a cold air flow (“secondary flow”) that circulates outside the turbojet engine through an annular passage, also called “tunnel.”

A turbojet engine usually includes a so-called “upstream” part comprising the fan blades and a so-called “downstream” part housing the gas generator.

A nacelle for such an engine generally has an outer structure, called Outer Fixed Structure (OFS), and a concentric inner structure, called Inner Fixed Structure (IFS), surrounding the structure of the engine strictly speaking downstream of the fan. The inner and outer structures define a tunnel intended to channel the cold air flow that circulates outside the engine. The primary and secondary flows are discharged from the engine through the rear of the nacelle.

A nacelle structure must bear all of the forces it undergoes both in flight and on the ground, in particular any overpressure occurring when the high-pressure hose(s) burst(s).

Nacelles are known including hinged overpressure hatches making it possible to access certain components of the turbojet engine. However, to do so, said overpressure hatch is hinged so as to contain its opening with displacement so as not to impact the structure of the surrounding nacelle. It is also electrically connected to the mass of the nacelle.

However, this type of hatch known at this time is metal, heavy, costly, and complex to adjust to trigger the opening at the correct overpressure value.

### BRIEF SUMMARY

One aim of the present invention is therefore to provide an overpressure hatch for a nacelle that is effective, easy to use, light, and inexpensive.

To that end, according to a first aspect, the invention relates to an overpressure hatch intended to be mounted on a wall of a turbojet engine nacelle, the overpressure hatch including a support intended to be fixed on the wall and at least one discharge element able to move in relation to said support, characterized in that it comprises at least one part of lower mechanical strength than the rest of the overpressure hatch so as to discharge the overpressure air inside the nacelle when the level of the internal pressure exerted on said hatch substantially reaches a threshold pressure level lower than the maximum pressure borne by the structure of the nacelle.

The wall of the nacelle can be an outer wall, said wall being in contact with the flow of air deflected around the nacelle, or an inner wall, said wall being in contact with the air flow penetrating inside said nacelle.

The inventive hatch has one or several parts of lower mechanical strength than the rest of the hatch according to the invention and the nacelle structure. In this way, in the event one or more overpressure hoses situated in the side the nacelle burst, the part(s) absorb the forces exerted on said hatch, in particular by deforming or breaking, before the rest of the inventive hatch and the nacelle structure when the internal pressure is lower than the maximum pressure borne by the nacelle structure. The overpressure air inside the nacelle is then discharged by the discharge element(s) simply and effectively. It is therefore no longer necessary to adjust the triggering of the opening of the overpressure hatch as was the case in the prior art, which makes it possible to reduce the installation cost. The production cost as well as the mass of such a hatch are also reduced inasmuch as the inventive hatch includes fewer components than the traditional overpressure hatches. It is also possible to consider manufacturing the inventive hatch in light non-metal materials.

“Inside of the nacelle” here refers to the space defined by the walls of the nacelle, this space not comprising the tunnel in which the cold air flow circulates and which is formed by the inner fixed structure and the outer fixed structure.

According to other features of the invention, the inventive hatch includes one or more of the following optional features, considered alone or according to all possible combinations:
the part(s) can deform or break so as to discharge the overpressure air inside the nacelle when the level of the pressure exerted on the discharge element(s) reaches the threshold pressure level, which allows better absorption of the forces created on the inventive hatch;
the threshold value is between 0.02 bar and 0.15 bar;
at least one discharge element comprises a panel having at least one cutting line able to break when the level of the pressure exerted on the panel reaches the threshold pressure level, and a bend line around which said panel can rotate, which allows a simple design of the hatches according to the invention;
at least one discharge element comprises a panel comprising a wear line able to break when the level of the pressure exerted on the panel reaches the threshold pressure level, which makes it possible to discharge the overpressure using a device that is easy to make;
the wear line is made up of a groove oriented so as to be in contact with the overpressure air, which makes it possible to adapt the mechanical strength as a function of the desired threshold pressure value;
a discharge element is a door whereof the locking system includes at least one wear line, which makes it possible to access the equipment situated inside the nacelle in case of emergency;
the wear line is incorporated into a tongue able to slide in a corresponding housing fixed in the support, which makes it possible to replace the part of lower mechanical strength more easily;
the discharge element(s) include at least one door able to deform elastically to free itself from the support when the level of the internal pressure exerted on said hatch substantially reaches the threshold pressure level, which makes it possible to make both the discharge element(s) and the part of lower mechanical strength simply and inexpensively;
the hatch according to the invention is sandwiched between an inner plate intended to be mounted towards the inside of the nacelle in contact with the flow of overpressure air and an outer plate intended to be mounted towards the outside of the nacelle in contact with the flow of air outside the nacelle, said inner and outer plates being fixed using fixing means through said overpressure hatch;
the inner plate includes at least one rupture element able to break when the level of the internal pressure exerted on the hatch substantially reaches the threshold pressure level, which participates in the discharge of the pressurized air;
the rupture element is a groove able to break when the level of the pressure exerted on the inner panel reaches the threshold pressure level;
the hatch according to the invention includes a central part and a side part, the side part being able to deform so as to allow the central part to be lifted like a valve in order to discharge the overpressure air;
the inventive hatch substantially covers a grate intended to be mounted inside the nacelle in contact with the flow of overpressure air, said grate being configured to orient part of the flow of overpressure air towards the outside of the nacelle, which makes it possible to control the orientation of part of the flow of pressurized air;
the discharge element(s) and/or the part(s) are made from a thermoplastic material, which makes it possible to lighten the mass of the inventive hatch and limit the manufacturing costs thereof.

According to another aspect, the invention relates to a turbojet engine nacelle, characterized in that it includes at least one hatch according to the invention.

Preferably, the inventive nacelle includes several hatches according to the invention capable of discharging the overpressure air inside the nacelle at different threshold levels.

### BRIEF DESCRIPTION OF THE DRAWINGS

The invention will be better understood upon reading the non-limiting description that follows, done in reference to the appended figures.

FIG. 1 is a transverse diagrammatic cross-section of a nacelle according to the invention surrounding a turbojet engine;

FIG. 2 is a diagrammatic view of one embodiment of the inventive hatch mounted on an outer wall of a nacelle according the invention, the hatch being in the closed position;

FIGS. 3 and 4 are a front view and a transverse cross-sectional view, respectively, of one alternative of the inventive hatch shown in FIG. 2 on the nacelle according to FIG. 1;

FIG. 5 is a transverse cross-section of the inventive hatch shown in FIGS. 3 and 4 in the open position after a pressurized hose has burst;

FIG. 6 is a front view of an alternative of FIG. 3;

FIGS. 7 and 8 are a front view and a transverse cross-sectional view, respectively, of the inventive hatch shown in FIG. 2, in the closed position and the open position, respectively;

FIGS. 8 and 9 are transverse cross-sections of another embodiment of the inventive hatch shown in FIG. 2 in the closed and open position, respectively;

FIGS. 10 and 11 are a front view and a transverse cross-sectional view of an alternative of the inventive hatch shown in FIG. 2;

FIGS. 12 to 14 are transverse cross-sections of another embodiment of the inventive hatch shown in FIG. 2, in the closed position, the beginning of opening position, and the open position, respectively;

FIGS. 15 and 16 are transverse cross-sections of another embodiment of the inventive hatch shown in FIG. 2, in the closed position and the open position, respectively;

FIGS. 17 and 18 are transverse cross-sections of another embodiment of the inventive hatch shown in FIG. 2, in the closed and open position, respectively;

FIGS. 19 to 21 are transverse cross-sections of another embodiment of the inventive hatch shown in FIG. 2, in the closed position, the beginning of opening position, and the open position, respectively.

### DETAILED DESCRIPTION

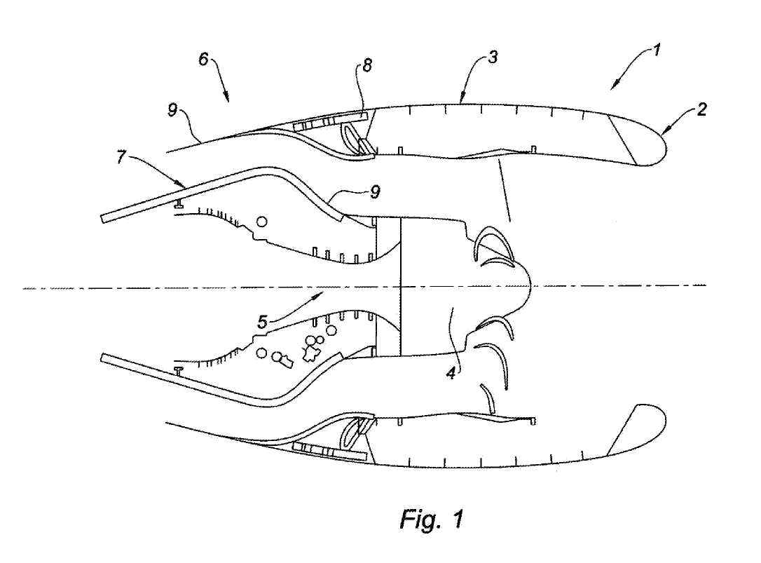

As shown in FIG. 1, a nacelle 1 according to the invention comprises an air intake lip 2, a central structure 3 surrounding a fan 4 of a turbojet engine 5, and a downstream assembly 6. The downstream assembly 6 is made up of an inner fixed structure 7 (IFS) surrounding the upstream part of the turbojet engine 5, an outer fixed structure 8 (OFS), and a mobile cowl 9 including thrust reverser means. The inner fixed structure 7 and the outer fixed structure 8 define a tunnel in which a cold air flow circulates penetrating the nacelle 1 according to the invention. In this way, the cold air flow and the air flow surrounding the nacelle constitute the “outer air flow” that surrounds the nacelle 1 according to the invention.

The nacelle 1 according to the invention includes inner elements (not shown) participating in the operation of the turbojet engine 5 or the nacelle 1 according to the invention. Part of these elements are supplied by overpressure hoses (not shown) in which the pressurized air circulates.

The hatch according to the invention makes it possible to discharge the overpressure air coming from the bursting of one or more of these hoses.

The overpressure hatch is intended to be mounted on a wall outside the nacelle 1 according to the invention. The wall is intended to be in contact with the outer air flow, which is not overpressure air. In particular, the wall can be the outer wall of the nacelle, i.e. the wall in contact with the flow of air deflected around the nacelle 1 according to the invention such as the outer wall of the mobile cowl 9 or of the central structure 3 or the inner wall in contact with the cold air flow penetrating the nacelle according to the invention such as the inner wall of the IFS 7.

The inventive hatch includes a support intended to be fixed on the outer wall and at least one discharge element able to move in relation thereto. The inventive hatch comprises at least one part of lower mechanical strength than the rest of the overpressure hatch so as to discharge the overpressure air inside the nacelle 1 according to the invention when the level of the internal pressure exerted on said hatch substantially reaches a threshold pressure level lower than the maximum pressure borne by the structure of the nacelle 1 according to the invention. Preferably, the part(s) can deform or break so as to allow the discharge element(s) to discharge the overpressure air inside the inventive nacelle when the level of the pressure exerted on the discharge element(s) reaches the threshold pressure level. The discharge element(s) can comprise the part(s) of lower mechanical strength.

In this way, the outer wall having a lower mechanical strength than the parts of the inventive hatch, said wall is not damaged by the overpressure in the event the overpressure hose breaks. It is therefore not necessary to repair part of the outer wall that would have been damaged, but to replace, if necessary, the inventive hatch with an identical undamaged hatch. The repair time on the ground is therefore advantageously shortened.

Furthermore, the size of the inventive hatch is smaller relative to the prior art because it is no longer necessary for practically the majority of the surface to bear the overpressure. Only the mechanically weakened area corresponding to the part(s) breaks when an internal pressure level reaches that of the threshold pressure. As a result, such a reduction in the size of the inventive hatch allows savings in terms of mass, components, and production cost.

The level of the threshold pressure is in particular between 0.01 bar and 0.25 bar, or between 0.015 bar and 0.20 bar, preferably between 0.02 bar and 0.15 bar.

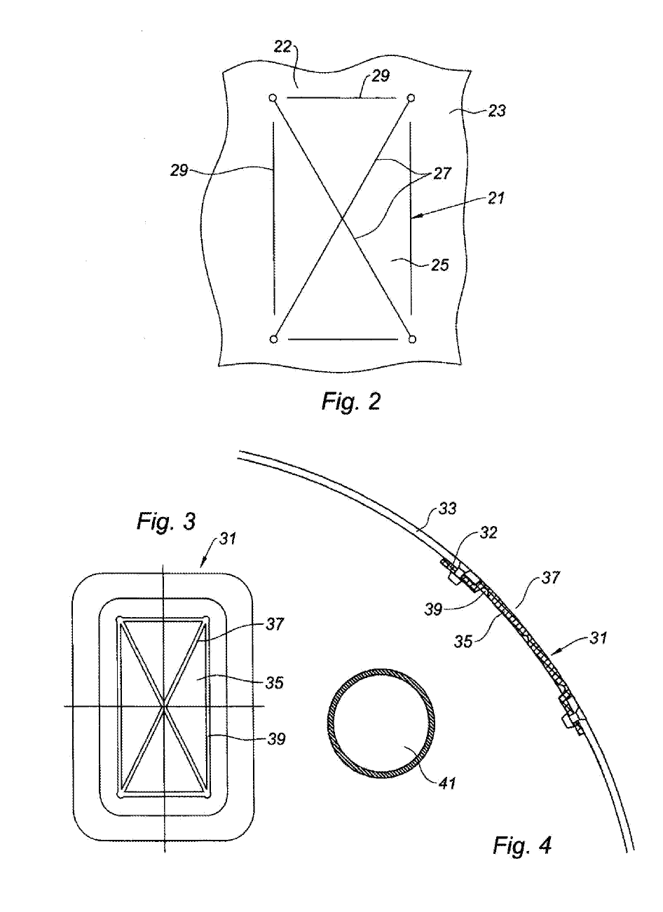

According to a first embodiment shown in FIG. 2, the support 22 of the inventive hatch 21 is incorporated into the very structure of the outer wall 23 of the inventive nacelle 1, in particular the mobile cowl 9 or the central structure 3. To that end, the outer wall 23 is made from several layers of fabric, such as glass cloth, which makes it possible to simplify the implementation of the inventive hatch 21.

It is possible for a surface web layer to top the inventive hatch 21 in order to preserve the capacity of the surface of said hatch 21 to withstand a lightning impact. Said layer can have a substantially crossed cutout.

The outer wall 23 and the hatch 21 according to the invention have a continuous outer surface so as to ensure aerodynamic smoothing.

The outer wall 23 incorporating the inventive hatch 21 can have a specific arrangement of the layers of fabric using any means known by those skilled in the art. In this way, some areas can include complete or partial cutouts of the layers of fabric thereby forming one or more parts of lower mechanical strength. Other areas may not include any so as to ensure the mechanical integrity of the inventive nacelle 1.

In this way, the at least partially cut out areas define one or more discharge elements delimited by at least one part of lower mechanical strength relative to the rest of the inventive nacelle 1. In the embodiment shown in FIG. 2, the parts of lower strength are cutting lines 27 able to break in the event of an overpressure by defining at least one panel 25 as discharge element(s).

The cutting lines 27 can be positioned in a cross as shown in FIG. 2, or according to any other suitable pattern known by those skilled in the art.

Furthermore, in this embodiment, at least one bend line 29 is also provided to allow the panel(s) 25 to pivot relative to the support 22. The bend lines 29 have a greater mechanical strength than the cutting lines 27 so as not to lose discharge element(s) 25 of the inventive hatch when the aircraft is in flight.

In general, the choice of a rupture line or a deformation determines the nature of the material used to make the part(s) and the discharge elements of the inventive hatch. If a rupture is considered, the material used is hard and breakable; if, on the other hand, deformation is desired, a less hard material is favored. In this way, preferably, the discharge element(s) 25 of the inventive hatch are made from a thermoplastic material, in particular polypropylene possibly reinforced by 20% to 30% by mass of glass fiber or mica. Shock strength can be improved by adding 20% to 40% by mass of an elastomer, such as butyl polyacrylate.

In the case of a hatch 21 according to the invention incorporated into an outer wall 23, the outer wall can also be made from the same thermoplastic material as that of the discharge element(s) 25 of the inventive hatch.

In the event the inventive hatch 21 and/or the outer wall 23 are made from a thermoplastic material, said hatch 21 and/or said wall 23 are in particular obtained by molding.

According to another embodiment shown in FIG. 3, the hatch 31 according to the invention comprises at least one discharge element in the form of a panel 35 comprising a wear line 37 able to break when the level of the pressure exerted on the panel 35 reaches the threshold pressure level. In this way, any risk of untimely opening of the hatch 31 is prevented.

As shown in FIG. 4, the inventive hatch 31 is attached by the support 32 on an outer wall 33 using any means known by those skilled in the art, in particular by one or more rivets. The wear line(s) 37 are preferably made by more or less deep inner grooves depending on the expected rupture level.

One or more hinge lines 39 are also formed in order to allow the panel(s) 35 to pivot around the support 32.

The wear line(s) 37 intended to rupture are mechanically weaker than the hinge groove(s) 39.

Typically, the wear line(s) 37 are positioned towards the center of the hatch 31 according to the invention whereas the hinge line(s) 49 are arranged substantially at the periphery of said hatch 31 so as to allow the panel 35 to pivot in relation to the support 32 around the hinge lines 39 when the level of the pressure exerted on the panel 35 reaches the threshold pressure level.

The wear lines 37 and/or hinge lines 39 can be made in the form of grooves.

The groove(s) are oriented so as to be in contact with the overpressure air. In other words, the groove(s) are oriented radially towards the outside of the inventive nacelle 1. Thus, before the wear line(s) 37 break at the corresponding groove, the outer surface of the inventive hatch 31 combines with the aerodynamic lines of the structure of the inventive nacelle 1.

The groove(s) can be continuous or partial with a continuous or evolving thickness.

The groove(s) can have any shape, in particular with a substantially triangular or circular transverse section.

A groove forming a wear line 37 is deeper than a groove forming the hinge line 39 so that the first groove breaks at a lower pressure than the second groove. In this way, the overpressure strength of a groove depends on the thickness of the remaining material associated with the length of the groove. In the event the transverse section of the groove is substantially circular, a significant radius of the groove, i.e. in particular greater than 3 mm, makes it possible to limit the concentration of forces on the groove and thereby to increase the mechanical strength.

Typically, the bottom thickness of a groove of a wear line 37 is between 1 mm and 3 mm, or between 2 mm and 5 mm.

Typically, the bottom thickness of a groove of a hinge line 39 is between 2 mm and 4 mm, or between 3 mm and 6 mm.

The outer surface of the inventive hatch 31 can receive a treatment such as a web to support and diffuse a strong electrical charge, for example from lightning. The electrical continuity with the structure of the outer wall 33 can be relayed by the fastenings of the hatch 31 according to the invention.

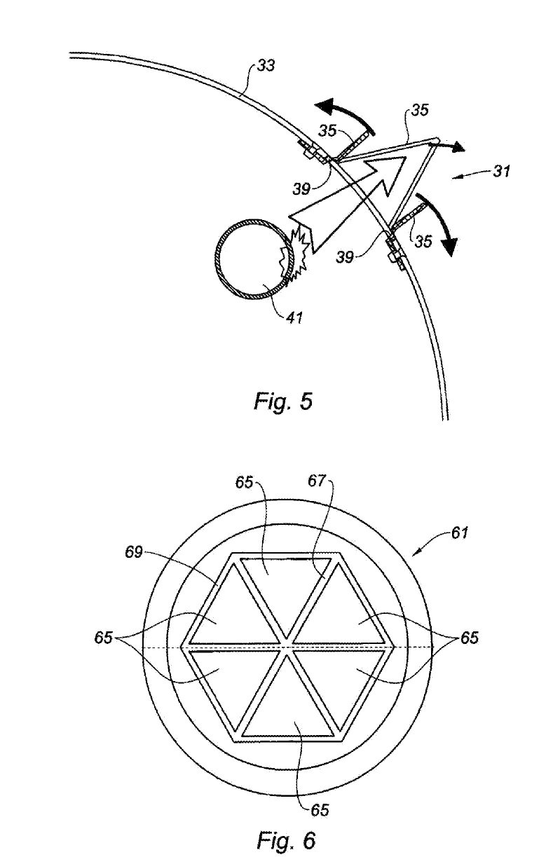

As shown in FIG. 5, when a hose 41 bursts inside the inventive nacelle 1, an overpressure invades the inside of the said nacelle 1. The pressure is then uniformly distributed. Since the wear line(s) 37 have a lower mechanical strength than the rest of the structure, the discharge element(s) 35 open around the hinge line(s) 39 after the wear liens 37 have torn at their groove.

In general, each discharge element 25, 35 of the inventive hatch can have any shape and any size adapted and known by those skilled in the art, in particular triangular, hexagonal, octagonal shapes. The decrease in the surface area of the discharge element 25, 35 makes it possible to decrease the action speed of the pressure on said elements 25, 35. In this way, the part(s) 27, 37 of low mechanical strength resist for a longer time before breaking.

According to the embodiment shown in FIG. 6, the inventive hatch 61 includes wear lines 67 and hinge lines 69 substantially defining a hexagon formed by six discharge elements, in the form of six panels 65.

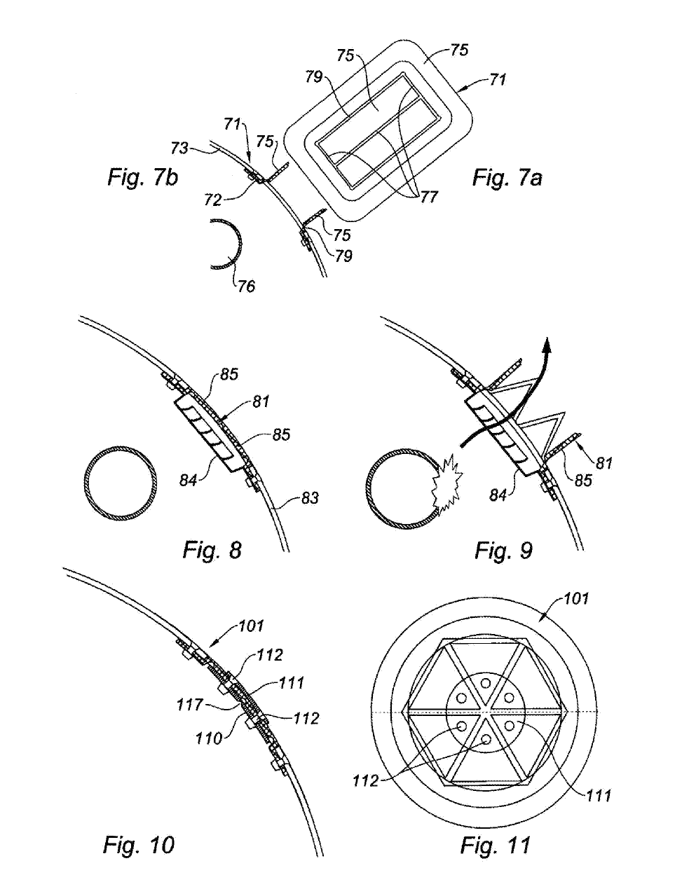

According to the embodiment shown in FIG. 7a, the inventive hatch 71 includes a support 72 fixed on the outer wall 73 of the inventive nacelle using any means known by those skilled in the art and several discharge elements 75. In that case, the discharge elements 75 are longitudinal panels 75 oriented substantially along the outer air flow. As a result, the parts of low mechanical strength 77 define, with the hinge lines 79, the panels 75. The parts 77 are in the form of wear lines 77 able to break, at least one of which is oriented substantially along the flow of air outside the nacelle. In this way, the longitudinal panels 75 are oriented so as to be aligned with the wind created by said flow of air outside the inventive nacelle 1. The hinge lines 79 around which the longitudinal panels 75 can pivot are also oriented substantially longitudinally along the direction of the overpressure air flow.

Thus, as shown in FIG. 7b, when one or more of the overpressure hoses 76 burst inside the inventive nacelle 1, the panels 75 open and are aligned with the direction of the air flow outside the inventive nacelle 1. Thus, elements of the inventive trap 71 do not close or flap during flight.

Typically, the wear lines 77 and the hinge lines 79 are grooves with different depths like those described above.

Generally, after an overpressure hose bursts, the turbojet engine can continue to operate by supplying pressurized air inside the inventive nacelle 1. It is possible to control at least part of the pressurized air flow inside the inventive nacelle 1 by guiding the flow in a desired direction. The flow can be guided by a system of grids associated with at least one hatch according to the invention. In this way, the aerodynamic performance of the inventive nacelle 1 is less affected by a raw discharge of overpressure air. According to the embodiment of FIGS. 8 and 9, the inventive hatch 81 substantially covers such a grid 84 intended to be mounted inside the nacelle 1 according to the invention in contact with the flow of overpressure air, said grid 84 being configured to orient part of the flow of overpressure air towards the outside of said nacelle 1 according to the invention. To that end, said grid 84 can comprise a multitude of fins spaced apart having a shape going in the direction of the flow of air.

The grid 84 can be attached and fixed with the inventive hatch 81 using any means known by those skilled in the art, in particular one or more rivets.

According to one alternative, the grid 84 is attached independently of the inventive hatch 81 on the outer wall 83 of the nacelle 1 according to the invention or on an element situated inside said nacelle 1.

The grid 84 can also be incorporated into the structure of the inventive hatch 81 so as to form a single-unit piece.

The grids 84 can be made from a metal material, such as aluminum, making it possible to apply increased lightning protection relative to the inner part of the structure of the inventive nacelle 1 after opening the discharge elements, in this case panels 85. In this way, if lightning strikes the area of the inventive hatch 81, the impact of the lightning can be situated either on the ends of the panels 85 connected to the mass of the inventive nacelle 1, or on the grid 84 then serving as a diffuser towards the structure of the outer wall 83.

The inventive hatch 21, 31, 61, 71 and 81 can be used to serve as emergency access for the inner elements of the nacelle 1 according to the invention. In this way, the inventive hatch 21, 31, 61, 71 and 81 can be sacrificed at the parts of lower mechanical strength 27, 37, 67 and 77 to access equipment inside the nacelle 1, such as jacks or bolts so as to be able to unlock these elements in the event one of the two breaks down, for example.

To that end, it is possible to affix a placard on the outer surface of the inventive hatch 21, 31, 61, 71 and 81 to indicate the impact point to be applied to pierce said hatch 21, 31, 61, 71 and 81 and to thereby access the considered elements.

The inventive hatch can also be repaired temporarily in order to prevent the aircraft from being immobilized on the ground.

According to the embodiment shown in FIGS. 10 and 11, the hatch 101 according to the invention is sandwiched between an inner plate 110 intended to be mounted towards the inside of the nacelle 1 according to the invention in contact with the overpressure air flow, and an outer plate 111 intended to be mounted towards the outside of the nacelle 1 according to the invention in contact with the outer air flow. Said inner 110 and outer 111 plates are fixed by fixing means 112 through said inventive hatch 101. The fixing means 112 can be rivets.

Preferably, the inner plate 110 includes at least one rupture element 117 able to break when the level of the internal pressure exerted on the inventive hatch 101 substantially reaches the threshold pressure level, which participates in discharging the pressurized air. The rupture element 117 can be a wear line able to break when the level of the pressure exerted on the inner panel 110 reaches the threshold pressure level. The wear line can be made up of a groove like those previously described, said groove being deep enough to break when the internal pressure level reaches that of the threshold pressure. The wear line can also be formed by stacking, i.e. by overlapping lateral ends of two parts making up the inner plate 110.

The outer plate 111 can also include such rupture elements.

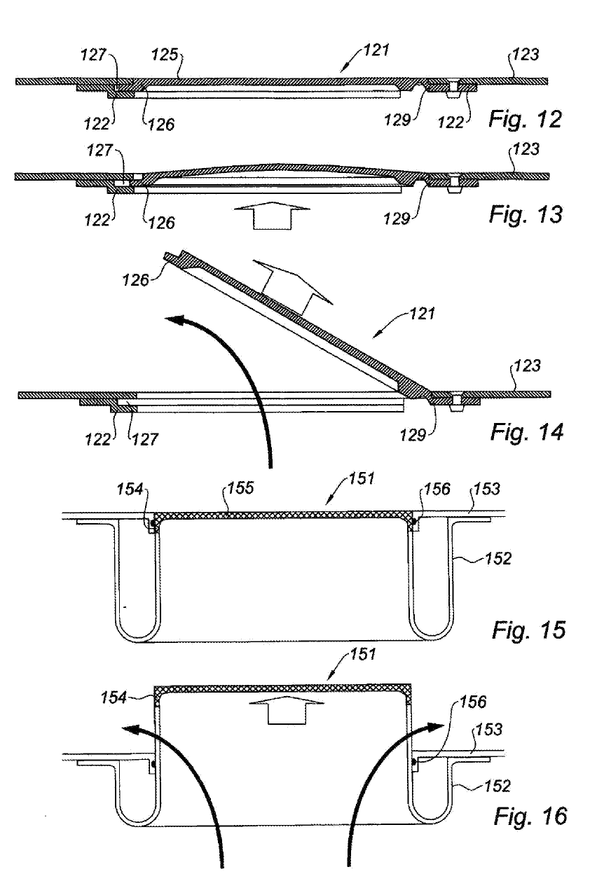

According to another embodiment shown in FIGS. 12 to 14, the inventive hatch 121 includes a support 122 that can be fixed on the outer wall 123 of the inventive nacelle 1 and one or more discharge elements in the form of a door 125 able to deform elastically to free itself from the support 122 when the level of the internal pressure exerted on said hatch 121 substantially reaches the threshold pressure level. “Elastic” designates a deformation during which the discharge element is able to substantially return to its idle configuration.

The door 125 can be made from a polymer material, such as polyethylene, which allows optimal elastic deformation of said door 125.

According to the embodiment in FIGS. 12 to 14, the door 125 forms a single-piece element with the support 122 on a first lateral side. According to another embodiment, the door 125 can be fixed to the support 122 using any means known by those skilled in the art. The door 125 has, on a second lateral side, a protuberance 126 able to become embedded in a slot 127 provided to that end in the support 122.

As shown in FIGS. 13 and 14, during an increase in the internal pressure greater than or equal to the threshold pressure level, the door 125 deforms, freeing the protuberance 126 from the slot 127, which causes said door 125 to open.

The door 125 therefore pivots in relation to the support 123 around a hinge line 129. It is possible for the door 125 to pivot around any other means suitable for that purpose known by those skilled in the art.

The hinge line 129 can be formed by a groove like those described above.

The opening direction of the door 125 depends on the desired effect. It can be done so that the released pressurized air flow is in the direction of forward motion during flight in order to impact the aerodynamic performance of the propulsion assembly.

According to an alternative shown in FIGS. 15 and 16, it is possible for the hatch 151 according to the invention to operate as a valve in the event one or more internal overpressure hoses burst. The hatch 151 according to the invention includes a central part 155 and a side part 152 serving as a support, the side part 152 being able to deform so as to allow the central part 155 to be lifted like a valve in order to discharge the overpressure air. To that end, the hatch 151 according to the invention can be made in a flexible material allowing a deformation in the desired zone, in particular at the side part 152. To that end, examples include polypropylene. It is also possible to use a material whereof the resilience makes it possible to return the inventive hatch 151 to the closed position. To that end, examples include any spring steel or bronze known by those skilled in the art.

The central part 155 tops a peripheral return 154 substantially perpendicular to the central part 155 and able to allow, in the closed position, a sealed connection between the hatch 151 according to the invention and the outer wall 153. The sealed connection can also be ensured by seals 156.

The hatch 151 according to the invention can be made in a single piece or can have one or more attached deformation lugs. In that case, the materials from which the inventive hatch 151 and the deformation lug(s) are made can be different.

In the closed position shown in FIG. 15, the outer surface of the hatch 151 according to the invention forms an aerodynamic continuity with the outer wall 153 inasmuch as, on one hand, the peripheral return 154 is embedded in the outer walls 153 and, on the other hand, the outer surface of the central part 155 is substantially aligned with said wall 153. During an internal overpressure, the pressure uniformly distributed on the inner surface of the central part 155 raises the latter. In this way, the overpressure air present inside the nacelle 1 according to the invention escapes through the orifices defined by the peripheral return 154 and the outer wall 153 while supplying exhaust membranes for the overpressure air.

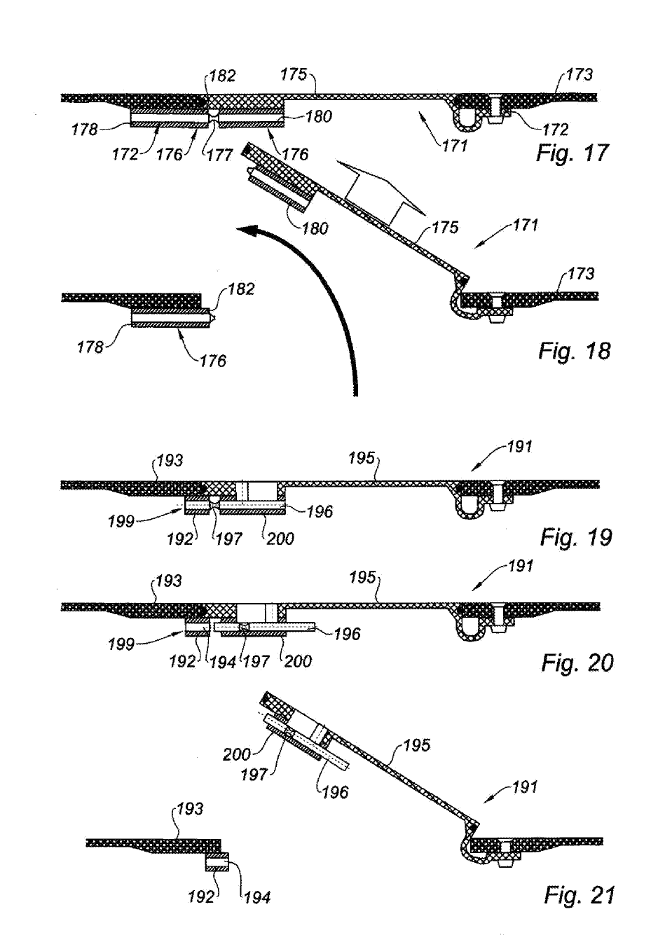

According to another embodiment shown in FIGS. 17 and 18, the hatch 171 according to the invention includes a support 172 mounted using any means known by those skilled in the art on the outer wall 173. The inventive hatch 171 also includes at least one discharge element in the form of a door 175 whereof the locking system 176 includes at least one rupture element able to break when the level of the pressure exerted on said hatch substantially reaches the threshold pressure level. In this way, it is possible to access the equipment situated inside the inventive nacelle 1 in case of emergency. In the embodiment illustrated in FIGS. 17 and 18, the support 172 is formed by an extension of a lateral side of the door 175. According to another embodiment, it is possible for the door 175 to be attached using any means known by those skilled in the art on the support 172. The door 175 can move by pivoting around a hinge incorporated into the door 175 or attached thereto such as systems of the hinge pin-hinge type.

The locking system 176 can be formed by a first part 178 and a second part 180 separated by a fusible groove 177 corresponding to the rupture element, when the level of the pressure exerted on the hatch 171 according to the invention substantially reaches the threshold pressure level. The first part 178 is fixed using any means known by those skilled in the art on the outer wall 173 and the second part 180 is fixed using any means known by those skilled in the art to the door 175. The support 172 is also formed by a first part 178 of the locking system 176.

In this way, in the closed position, when the door 175 is not subject to a pressure equal to or greater than the threshold pressure level, the locking system 176 keeps the door closed so as to ensure aerodynamic continuity with the outer wall 173. The closing can be made sealed by the presence of one or more seals.

The rupture element 177 can be made from any suitable material known by those skilled in the art, in particular a metal, such as 15-5PH stainless steel or Inconel®.

As shown in FIGS. 17 and 18, the first part 178 can have a protrusion 182 so as to make it possible to keep the door 175 substantially aligned with the outer wall 173.

As shown in FIG. 18, when the internal pressure exerted on the door 175 reaches the threshold pressure level, the force exerted by the pressure acting on the inner surface of the door 175 procures a shearing force at the fusible groove 177, which breaks by then separating the first part 178 from the second part 180. The door 175 is therefore no longer kept closed and therefore goes to the open position so as to allow the discharge of the overpressure air.

It is possible to repair the hatch 171 according to the invention by disassembling the locking system 176 split into two parts by an identical locking system having a fusible groove attaching the first part 178 and the second part 180.

In the alternative shown in FIGS. 19 to 21, the rupture element 197 of the hatch 191 according to the invention is incorporated into a tongue 196 able to slide in a corresponding housing 194 fixed in the support 192 forming a locking system 199. The support 192 is fixed using any means known by those skilled in the art to the outer wall 193. As before, the part 200 of the locking system incorporating the tongue 196 and the rupture element 197 is fixed on the door 195 forming a discharge element. A seal is placed between the door 195 and the outer wall 193 so as to ensure sealing in the closed position.

The rupture element 197 can be made from any suitable material known by those skilled in the art, in particular a metal, such as 15-5PH stainless steel or Inconel®.

In this way, the inventive hatch 191 can be used both as an access hatch and an overpressure hatch.

According to an embodiment that is not shown, the inventive nacelle 1 includes a plurality of hatches 21; 31; 61; 71; 81; 101; 121; 151; 171; 191 according to the invention as previously described that are able to discharge the overpressure air inside the nacelle 1 at different threshold pressure values.

1. An overpressure hatch intended to be mounted on a wall of a turbojet engine nacelle, the overpressure hatch comprising:
a support intended to be fixed on the wall and;
at least one discharge element able to move in relation to said support and able to discharge overpressure air inside the nacelle;
at least one part of lower mechanical strength than the rest of the overpressure hatch so that the discharge element(s) can discharge the overpressure air inside the nacelle when a level of the internal pressure exerted on said hatch substantially reaches a threshold pressure level lower than a maximum pressure borne by the structure of the nacelle.

2. The hatch according to the claim 1, wherein the threshold value is between 0.02 bar and 0.15 bar.

3. The hatch according to claim 1, wherein at least one discharge element comprises a panel having at least one cutting line able to break when the level of the pressure exerted on the panel reaches the threshold pressure level, and a bend line around which said panel can rotate.

4. The hatch according to claim 1, wherein at least one discharge element comprises a panel comprising a wear line able to break when the level of the pressure exerted on the panel reaches the threshold pressure level and a fold line around which the panel rotates.

5. The hatch according to claim 4, wherein the wear line is made up of a groove oriented so as to be in contact with the overpressure air.

6. The hatch according to claim 1, wherein a discharge element is a door whereof a locking system includes at least one wear line.

7. The hatch according to claim 6, wherein the wear line is incorporated into a tongue able to slide in a corresponding housing fixed in the support.

8. The hatch according to claim 1, wherein the discharge element(s) include at least one door able to deform elastically to free itself from the support when the level of the internal pressure exerted on said hatch substantially reaches the threshold pressure level.

9. The hatch according to claim 1, wherein the hatch is sandwiched between an inner plate intended to be mounted towards an inside of the nacelle in contact with the flow of overpressure air and an outer plate intended to be mounted towards an outside of the nacelle in contact with the flow of air outside the nacelle, said inner and outer plates being fixed using fixing means through said overpressure hatch.

10. The hatch according to claim 9, wherein the inner plate includes at least one rupture element able to break when the level of the internal pressure exerted on the hatch substantially reaches the threshold pressure level.

11. The hatch according to claim 1, wherein the rupture element is a groove able to break when the level of the pressure exerted on the inner panel reaches the threshold pressure level.

12. The hatch according to claim 1, further comprising a central part and a side part, the side part being able to deform so as to allow the central part to be lifted like a valve in order to discharge the overpressure air.

13. The hatch according to claim 1, wherein the hatch substantially covers a grate intended to be mounted inside the nacelle in contact with the flow of overpressure air, said grate being configured to orient part of the flow of overpressure air towards the outside of the nacelle.

14. The hatch according to claim 1, wherein the discharge element(s) and/or the part(s) are made from a thermoplastic material or a metal material.

15. A turbojet engine nacelle, wherein it includes at least one hatch according to claim 1.

16. The nacelle according to claim 15, further comprising a plurality of hatches according to claim 1 able to discharge overpressure air inside the nacelle at different threshold pressure levels.
